(19) United States
(12) Patent Application Publication
(10) Pub. No.: US 2011/0058760 A1
(43) Pub. Date: Mar. 10, 2011

(54) Bearing Assembly Comprising Woven Synthetic Fibres

(76) Inventor: David Brian Magnus, Calgary (CA)

(21) Appl. No.: 12/626,658

(22) Filed: Nov. 26, 2009

Related U.S. Application Data
(60) Provisional application No. 61/118,553, filed on Nov. 28, 2008.

(51) Int. Cl. F16C 33/02

(52) U.S. Cl. 384/280

(57) ABSTRACT

A bearing assembly comprises a shaft having a longitudinal axis, a sleeve supported concentrically about the shaft, and a tubular liner received between the shaft and the sleeve so as to be concentric therewith and so as to support the sleeve for rotation relative to the shaft. The tubular liner comprises synthetic fibres woven helically about the longitudinal axis of the shaft and a rigid surrounding material which surrounds the synthetic fibres. The sleeve also comprises synthetic fibres woven about the longitudinal axis of the shaft and a rigid surrounding material which surrounds the synthetic fibres. The synthetic fibres may comprise glass fibres, polyester fibres, para-aramids, and/or Polytetrafluoroethylene fibres which are wound helically about the longitudinal axis. The surrounding material may comprise a thermoset material, a phenolic material, an epoxy, and/or a resin which is set to be rigid about the fibres.

This application claims the benefit under 35 U.S.C. 119(e) of U.S. provisional application Ser. No. 61/118,553, filed Nov. 28, 2008.

### FIELD OF THE INVENTION

The present invention relates to a bearing assembly supported for rotation about a shaft in which the bearing assembly comprises woven synthetic fibres in a surrounding thermosetting material, and more particularly relates to a bearing assembly in a conveying apparatus which conveys a continuous member into or out of a well.

### BACKGROUND

When conveying continuous members in a well, for example coiled tubing or continuous rod, it is common to use a conveying apparatus, for example a coiled tubing injector in the case of coiled tubing. A typical conveying apparatus comprises a pair of continuous drive chains supported on a frame to be rotatable within a generally common plane. The drive chains are positioned to comprise two opposed, elongate parallel runs spaced apart which form a path arranged to engage the continuous member passing therebetween. A pair of push members are typically arranged to apply pressure to the parallel runs to clamp the continuous member therebetween. Bearings and/or rollers are required in communication between the push members and the parallel runs of the pair of continuous drive chains. Conventional bearings used in conveying apparatuses of this type comprise a metal sleeve supported for rotation about a metal shaft, for example by roller bearings and the like. The resulting bearings have considerable mass and are subjected to considerable loading so that a short life span is typically expected.

### SUMMARY OF THE INVENTION

According to one aspect of the invention there is provided a bearing assembly comprising:

a shaft having a longitudinal axis;

a sleeve supported concentrically about the shaft; and

at least one tubular liner received between the shaft and the sleeve so as to be concentric therewith and so as to support the sleeve for rotation relative to the shaft;

said at least one tubular liner comprising synthetic fibres woven about the longitudinal axis of the shaft and a rigid surrounding material which surrounds the synthetic fibres.

The sleeve may also comprise synthetic fibres woven about the longitudinal axis of the shaft and a rigid surrounding material which surrounds the synthetic fibres.

The synthetic fibres of the tubular line and/or the sleeve may comprise glass fibres, polyester fibres, para-aramids, and/or Polytetrafluoroethylene fibres which are wound helically about the longitudinal axis.

The surrounding material may comprise a thermoset material, a phenolic material, an epoxy, and/or a resin which is set to be rigid about the fibres. Typically the surrounding material is applied in a liquid form to the synthetic fibres as the fibres are woven and then the surrounding material is heated for a prescribed period of time subsequent to being applied to the synthetic fibres as they are woven.

The bearing assembly is particularly suited for use in a conveying apparatus arranged for conveying a continuous member in a well bore so as to be supported in communication between the push members and the parallel runs of the pair of continuous drive chains of the conveying apparatus. In this application, the novel configuration of the bearing assemblies are much lighter than the prior art bearings to reduce some of the stress applied to the bearings while also having greater wear characteristics than prior art bearings so as to considerable extend the lifespan of the bearings.

Some embodiments of the invention will now be described in conjunction with the accompanying drawings in which:

### BRIEF DESCRIPTION OF THE DRAWINGS

FIG. 1 is a sectional view along a longitudinal axis of a first embodiment of the bearing assembly.

FIG. 2 is a sectional view along a longitudinal axis of a second embodiment of the bearing assembly.

FIG. 3 is an end elevational view of a further embodiment of the bearing assembly.

FIG. 4 is a sectional view along the line 4-4 of FIG. 3.

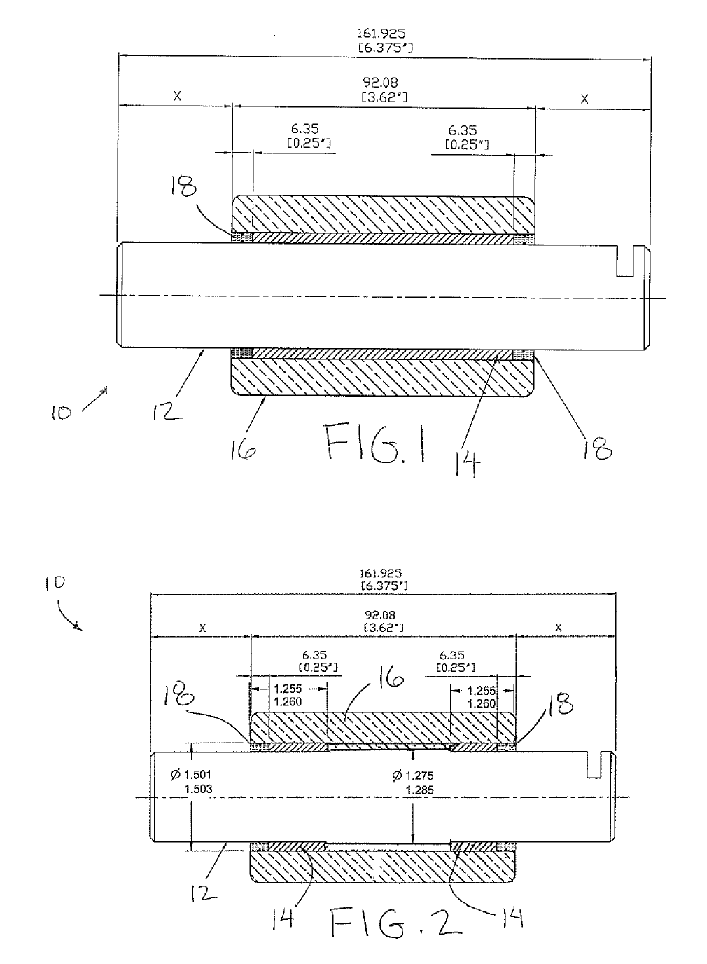

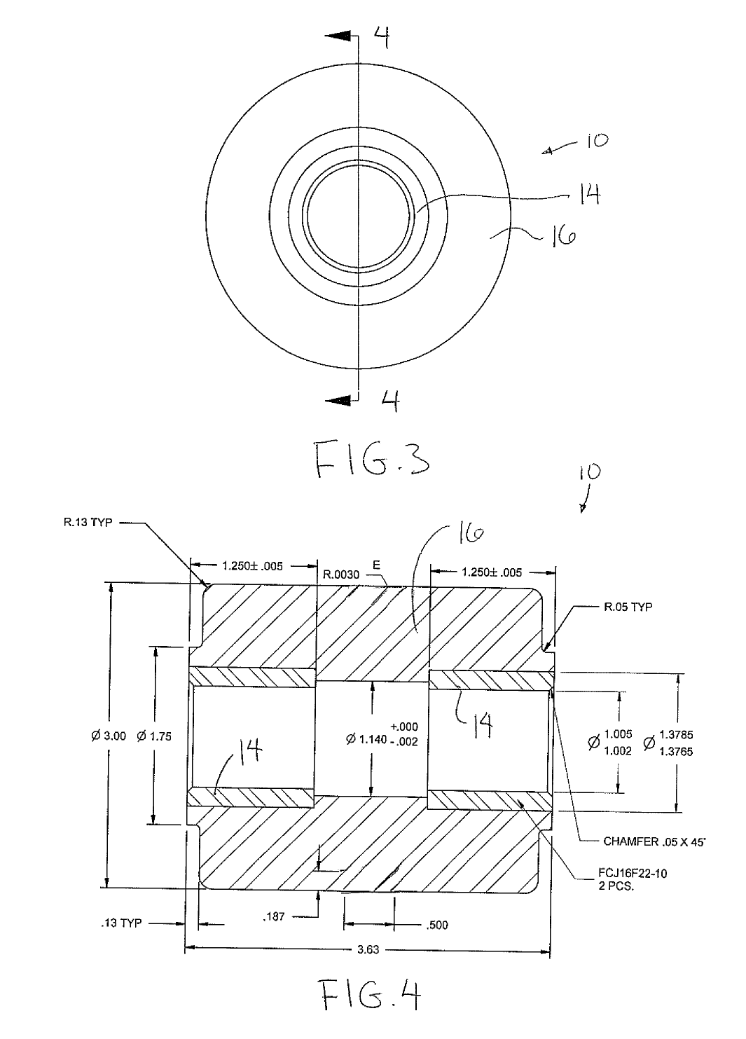

In the drawings like characters of reference indicate corresponding parts in the different figures.

### DETAILED DESCRIPTION

Referring to the accompanying Figures there is illustrated a bearing assembly generally indicated by reference numeral 10. As described herein, the bearing assembly 10 is particularly suited for use in a conveying apparatus arranged for conveying a continuous member in a well bore.

The bearing assembly 10 comprises a shaft 12 having a longitudinal axis. The shaft supports one or more tubular liners 14 concentrically thereabout.

The tubular liner(s) 14 support a sleeve 16 concentrically thereabout such that the sleeve is supported for rotation relative to the shaft. Sealing members 18 are provided in sealing engagement between the shaft 12 and the surrounding sleeve 16 at axially opposed ends of the sleeve 16.

Both the sleeve 16 and the tubular liner 14 comprises synthetic fibres woven about the longitudinal axis, and a rigid surrounding material which surrounds the synthetic fibres.

As described herein, the synthetic fibres typically comprise glass fibres, polyester fibres, para-aramids, and/or Polytetrafluoroethylene fibres which are wound helically about the longitudinal axis, while the surrounding material typically comprises a thermosetting material, a phenolic material, an epoxy, and/or a resin which is set or cured to be rigid about the fibres.

The rollers are made up of a thermoset polyester based epoxy with the supporting fibers being a combination of PTFE/Polyester and para-aramids. These fibers are woven in a specific pattern in continuous roles and are wetted using a semi-catalyzed resin. The now semi-wetted material is rolled onto mandrels under very high pressure and placed under pressure into an oven. During a 24-3 hour period the resin completes its catalyzation process and the material now becomes a rigid tube or sheet, depending on the process required.

The insert or liner materials are made very similarly except instead of using a woven laminate we use a helix specific e-glass filament wound material. The helix angle and number of winds/feed strands is determined by the wall thickness requirements and the load needs. The inner windings are generally a low angle helix for optimized shaft load strength. The outer winds are at a high angle helix and this is to allow for proper press fits and tight thermal expansion control. The resin system used is very similar to the roller material except that a wet wind continuous process is used. The liner materials are also “cooked” for 12-24 hours depending on the wall and load requirements. As far as the hardness, both components have a hardness of Rockwell M103-M105.

Furthermore, the bearing is a high load, low RPM bearing designed for rigorous industrial equipment applications. The bearing is manufactured by a filament winding process that results in a continuous fiberglass filament backing. This composition yields excellent mechanical properties especially fatigue resistance. The filament wound fiberglass structure uses a high strength, corrosion resistant epoxy resin as the matrix material. The high strength backing permits the use of a thin wall ( 1/16″ to ⅛″) bearing which can often reduce the size and weight of the finished bearing assembly. The bearing will support a bearing load of 30,000 PSI, while handling high radial and axial stresses. It resists high shock loading and impact fatigue due to their unique high strength continuous fiberglass backing. These qualities make the bearings ideal for high load operation in rotational and linear motion as well as in oscillation. This family of materials exhibits exceptional dimensional stability and performance predictability over wide temperature ranges (±325° F.).

The high strength composite fiberglass backing permits optimal strength and rigidity, with a modulus of elasticity of approximately 6×10̂6 PSI. This property allows the bearing to be rigid enough to support heavy loads and pliant enough to tolerate moderate shaft misalignments without over-stressing the bearing edges. The bearing surface is composed of a uniquely designed woven structure of PTFE filaments, which exhibit tensile strengths twenty times greater than PTFE resins. As a result, the bearing is not subject to cold flow under high loading conditions. These PTFE super-filaments are also the primary mechanism for allowing the product to operate in a true self-lubricating mode. No secondary lubrication is necessary, even during start-up conditions, due to the film transfer self-lubrication process.

At start-up the, the PTFE undergoes a phase change and smears around the mating pin surface. As the PTFE film develops, it transfers from the inner diameter to the outer diameter of the pin, smoothing out any macroscopic surface imperfections and allowing the bearing to have a very low coefficient of friction and minimal long-term wear, even under high loading conditions. In some conditions, as much as 0.001″ of wear may occur during the break-in period, while in other operations, break-in wear may be negligible. The elapsed time for break-in is PV (Pressure and Velocity) dependent. The equilibrium wear rate varies from operation to operation, due to a number of factors including: loads, speeds, shaft hardness, material, and shaft surface finish.

Following the break-in period, the wear rate stabilizes, remaining relatively constant for the bearings' life.

The bearings are designed to minimize wear; however, the bearing wear is affected by the general operating conditions, such as speed, sliding distance and load. With intermittent rotation or oscillation, radial wear should be negligible over thousands of hours. Hard chrome plating gives excellent wear performance and protects the shaft from corrosion. Coatings such as chrome, electroless nickel, or nitro carbonizing are all common treatments for shaft materials used with these bearings.

The bearing can withstand static loads of approximately 60,000 PSI and 30,000 PSI under dynamic loading. At these loading levels, minimum distortion will occur. For dry running applications, the maximum speed is approximately 10 surface feet per minute.

This bearing's operating temperature range is ±325° F. Maximum continuous operational surface temperature for the standard formulation is 325° F., depending upon load characteristics. The bearing has been heat stabilized at these temperatures, so that little dimensional change will occur in the bearing during operation. In a free state, the coefficient of expansion of the bearing is approximately 7×10-6 in/in/° F., similar to the coefficient of expansion for steel, and actually less than some metals.

Ultimate Compression Strength (PSI) . . . 60,000

Unit Load Limit (PSI) . . . 30,000

Temperature Range (Standard Formulation)* . . . ±325° F.

Coefficient of Thermal Expansion (in/in/° F.) . . . 7×10-6

Thermal Conductivity (BTU·in/(hr·Ft2·° F.) . . . 1.8-2.3

Water Absorption (2 hours) . . . 0.12%

Water Absorption (24 hours) . . . 0.16%

Specific Gravity . . . 1.87

Maximum Velocity (SFM) . . . 10

As described herein, the bearings are filament wound composite materials which offer very high strength, are self lubricating, thermally stable and offer low friction service with long life.

In some instances, the bearing uses a liner material by combining PTFE and synthetic braided fibers. This liner gives the end user a source of continuous lubrication from the PTFE while the secondary fiber offers abrasion resistance and improved wear life. The shell is a fiberglass filament wound in two distinct helix designs to offer different strengths through the shell wall. The resin system is very stable with a coefficient of thermal expansion the same as steel. This offers great stability across the full operating temperature range of cryogenic to 350 F. The bearing is non-corrosive and is compatible with any hardware condition without producing galvanic reactions.

In other instances, a special tape liner may be made from modified PTFE materials for improved wear and lower friction to reduce the coefficient of friction under 0.10 and as low as 0.05 without lubrication. In this instance, the product can be used for full rotary applications or higher speed linear applications.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A bearing assembly comprising:
a shaft having a longitudinal axis;
a sleeve supported concentrically about the shaft; and
at least one tubular liner received between the shaft and the sleeve so as to be concentric therewith and so as to support the sleeve for rotation relative to the shaft;
said at least one tubular liner comprising synthetic fibres woven about the longitudinal axis of the shaft and a rigid surrounding material which surrounds the synthetic fibres.

2. The bearing assembly according to claim 1 wherein the shaft comprises steel.

3. The bearing assembly according to claim 1 wherein the synthetic fibres comprise glass fibres.

4. The bearing assembly according to claim 1 wherein the synthetic fibres comprise polyester fibres.

5. The bearing assembly according to claim 1 wherein the synthetic fibres comprise para-aramids.

6. The bearing assembly according to claim 1 wherein the synthetic fibres comprise a mixture of fibres including some Polytetrafluoroethylene fibres.

7. The bearing assembly according to claim 1 wherein the synthetic fibres are wound helically about the longitudinal axis.

8. The bearing assembly according to claim 1 wherein the surrounding material comprises a thermoset material, an epoxy, or a resin.

9. The bearing assembly according to claim 1 wherein the surrounding material comprises a phenolic material.

10. The bearing assembly according to claim 1 wherein the surrounding material is applied in a liquid form to the synthetic fibres as the fibres are woven.

11. The bearing assembly according to claim 1 wherein the sleeve comprises synthetic fibres woven about the longitudinal axis of the shaft and a rigid surrounding material which surrounds the synthetic fibres.

12. The bearing assembly according to claim 11 wherein the synthetic fibres of the sleeve and said at least one tubular liner are wound helically about the longitudinal axis, the fibres of said at least one tubular liner being wound at a lower helical angle than the fibres of the sleeve.

13. The bearing assembly according to claim 11 wherein the synthetic fibres of the sleeve comprise glass fibres, polyester fibres, or para-aramids.

14. The bearing assembly according to claim 11 wherein the surrounding material of the sleeve comprises a thermoset material, an epoxy, or a resin.

15. The bearing assembly according to claim 11 wherein the surrounding material of the sleeve comprises a phenolic material.

16. The bearing assembly according to claim 11 wherein the surrounding material of the sleeve is applied in a liquid form to the synthetic fibres as the fibres are woven.

17. The bearing assembly according to claim 1 wherein there is provided a sealing member in between the sleeve and the shaft at opposing ends of the sleeve.

18. The bearing assembly according to claim 1 wherein said at least one tubular liner comprises a single tubular member spanning substantially a full length of the sleeve.

19. The bearing assembly according to claim 1 wherein said at least one tubular liner comprises a plurality of tubular members at axially spaced positions along the sleeve.

20. The bearing assembly according to claim 1 in combination with a plurality of bearing assemblies of like configuration and a conveying apparatus arranged for conveying a continuous member in a well bore in which the conveying apparatus comprises: a pair of continuous drive chains supported on the frame to be rotatable within a generally common plane and such that the drive chains comprise opposed, elongate parallel runs spaced apart to form a path arranged to engage the continuous member passing therebetween, and a pair of push members arranged to apply pressure to the parallel runs to clamp the continuous member therebetween, the bearing assemblies being supported in communication between the push members and the parallel runs of the pair of continuous drive chains.
